(19) United States
(12) Patent Application Publication
(10) Pub. No.: US 2006/0046031 A1
(43) Pub. Date: Mar. 2, 2006

(54) Graphic user interface having touch detectability

(75) Inventor: Angel Janevski, New York, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/537,127

(22) PCT Filed: Nov. 28, 2003
(86) PCT No.: PCT/IB03/05499

§ 371 Date: Jun. 2, 2005

Related U.S. Application Data
(60) Provisional application No. 60/430,915, filed on Dec. 4, 2002.

(51) Int. Cl. G06F 17/00

(52) U.S. Cl. 428/195.1; 715/835

(57) ABSTRACT

A control panel for a device which includes a graphical user interface (GUI) which displays several control icons that represent various control functions for the device. The control icons on the GUI have tactile detectability which is provided by either vibrotactile display, electrotactile display, or a combination of the two. A method of providing such a control panel is additionally disclosed.

This application is a continuation-in-part of copending U.S. patent application Ser. No. 10/174,284, filed on Jun. 18, 2002.

The subject invention relates to control panels having a flat panel graphic user interface (GUI). The invention further relates to a remote control having such a control panel. Consumer electronics devices are often provided with remote control units for controlling the device from the comfort of one's easy chair. These remote control units typically are rectangular in shape and carry a plurality of buttons for operating the various control functions of the electronic devices.

However, as the user acquires more and more devices, these remote control units start to accumulate leaving an array of remote control units on the user's coffee table with the problem of selecting the appropriate remote control unit for controlling the desired device. This problem has been addressed with universal remote control units which either include or may be programmed with the codes for controlling a plurality of different devices in a plurality of different device categories. As such, a user of such a universal remote control unit may control his/her stereo system, television receiver, video cassette recorder, DVD player, CD player, cable box, satellite receiver, etc., using the one universal remote control unit.

Quite naturally, it has now become a feat to design such a universal remote control unit which can be intuitively used to control all of these devices.

U.S. Pat. No. 5,956,025 discloses a remote control unit with 3D organized graphic user interface (GUI) for a home entertainment system which includes a GUI in the form of, for example, a liquid crystal display (LCD) with touch sensitivity in which various icons are displayed on the GUI and represent various control functions which the user selects in order to operate the various control functions of the various devices.

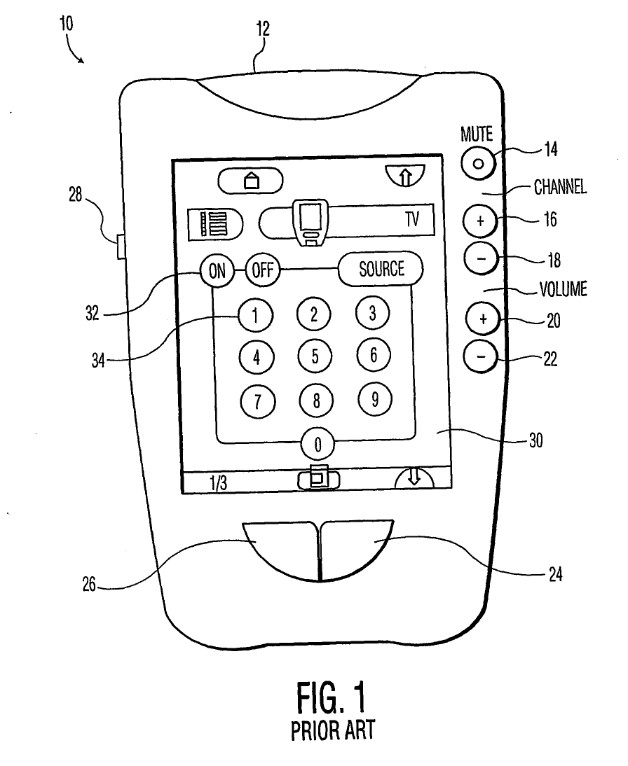

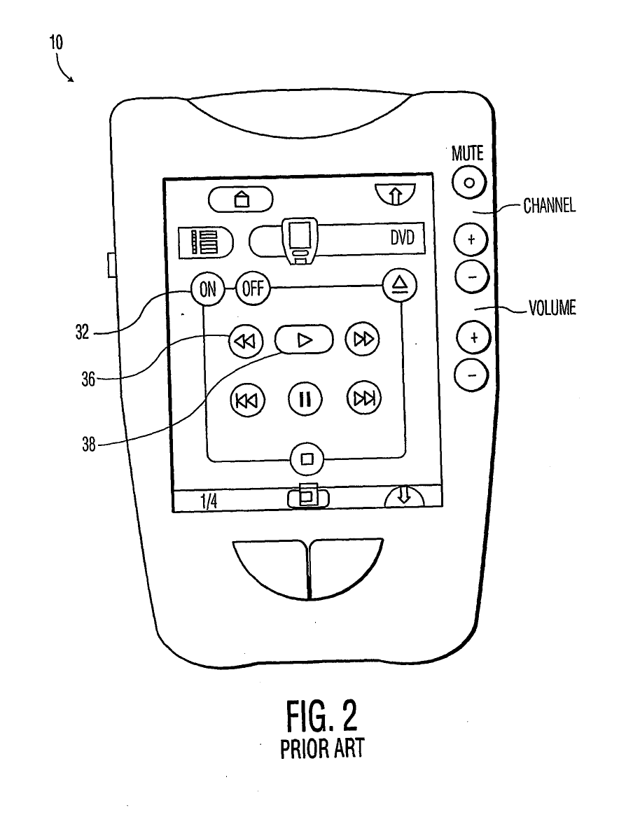

FIGS. 1 and 2 show an example of a remote control unit having such a GUI in the form of a touch sensitive LCD, which is marketed by Philips Electronics. As shown in FIG. 1, this remote control unit 10 includes an infrared transmitter for transmitting infrared control signals to the devices to be controlled. The remote control unit 10 includes a plurality of hard switches including a “MUTE” button 14, channel “UP” (16) and “DOWN” (18) buttons, volume “UP” (20) and volume “DOWN” (22) buttons, “RIGHT” (24) and “LEFT” (26) buttons for moving a cursor, and a “BACKLIGHT” button (28). The remote control unit 10 further includes a GUI in the form of a liquid crystal display 30 which displays various control icons for the device to be controlled. As shown in FIG. 1, the controlled device is a television receiver and the control icons include, e.g., “ON” (32) and the number “1” (34).

FIG. 2 shows the remote control unit 10 of FIG. 1, now set to control a DVD player, and has various control icons, e.g., “ON” (32), “REWING” (36), and “PLAY” (38).

However, one problem with these types of remote control units is that it is necessary for the user to look at the remote control unit in order to operate it. While this may not be a problem when using the remote control unit to operate an audio device, such as, a CD player, when the user is watching television, in many cases, the illumination in the room is dimmed to enhance the picture. As such, it is then difficult to discern the markings on the display of the remote control unit. While, for example, the remote control unit 10 of FIGS. 1 and 2 includes the button 28 for activating a back light for the display, the user still must take his/her eyes off of the television in order to reliably operate the remote control unit.

There exists a need for an improved remote control device to overcome these and other shortcomings.

It is an object of the invention to provide a control panel for a device which addresses the aforementioned and other shortcomings in the related art.

A first embodiment of the invention is a control panel for a device, comprising:

a graphical user interface (GUI) displaying a plurality of control icons, wherein the plurality of control icons represent a plurality of corresponding control functions for controlling the device; and

means for providing tactile detectability to said GUI to allow a user to detect at least one of the plurality of control icons by touch.

A second embodiment of the invention is a method comprising:

providing a control device including a display for displaying a graphical user interface (GUI);

displaying on the GUI a plurality of control icons representing various control functions wherein the control functions enable a user to control a system through the GUI; and

adapting at least one of the plurality of control icons so as to be detectable by a user via means selected from the group of vibrotactile means, electroctactile means, and combinations thereof.

With the above and additional objects and advantages in mind as will hereinafter appear, the subject invention will be described with reference to the accompanying drawings, in which:

FIG. 1 shows a plan view of a remote control unit having a graphic user interface (GUI) showing control icons for a television receiver in the related art;

FIG. 2 shows a plan view of the remote control unit of FIG. 1 in which the GUI shows the control icons for a DVD player;

FIG. 3 shows a plan view of a GUI portion of an embodiment, in accordance with the present invention;

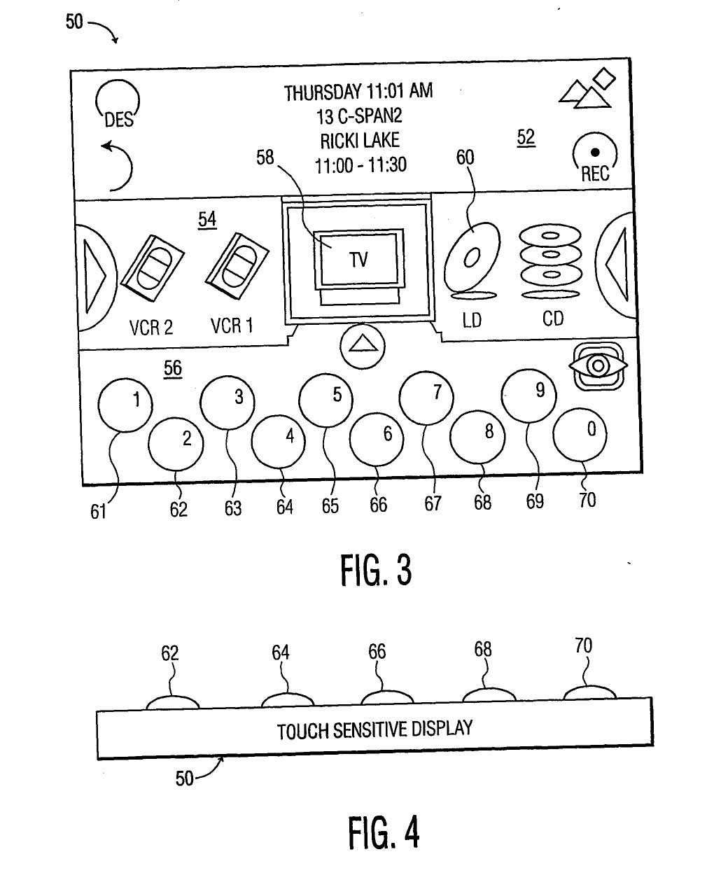

FIG. 4 shows an edge view of the GUI of the remote control unit of FIG. 3 incorporating a first embodiment of the subject invention;

FIG. 5 shows an edge view of the GUI of the remote control unit of FIG. 3 incorporating a second embodiment of the subject invention;

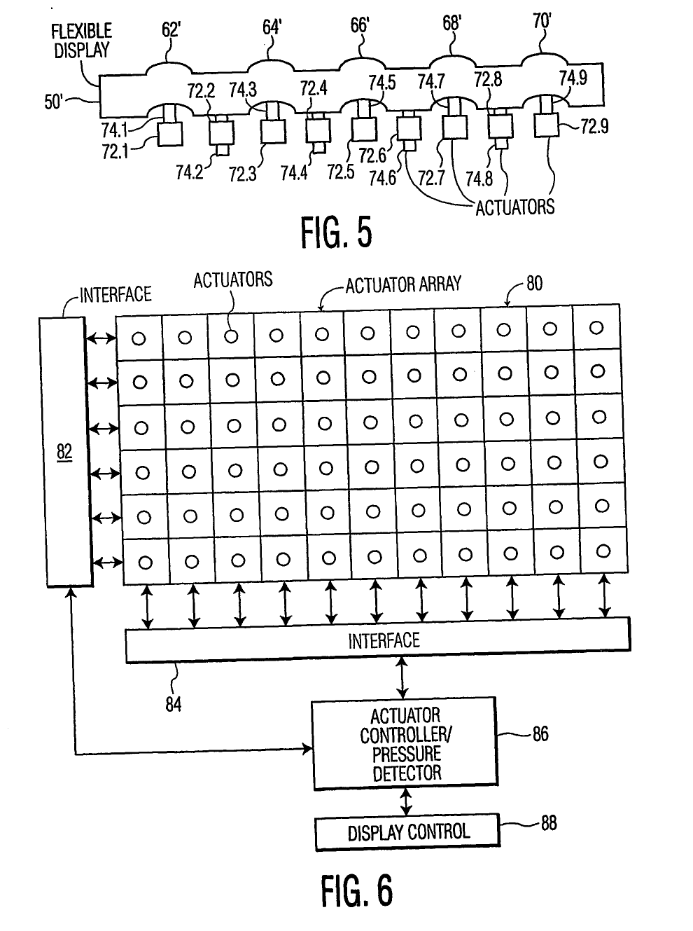

FIG. 6 shows an array of actuators and a block diagram for controlling the actuators.

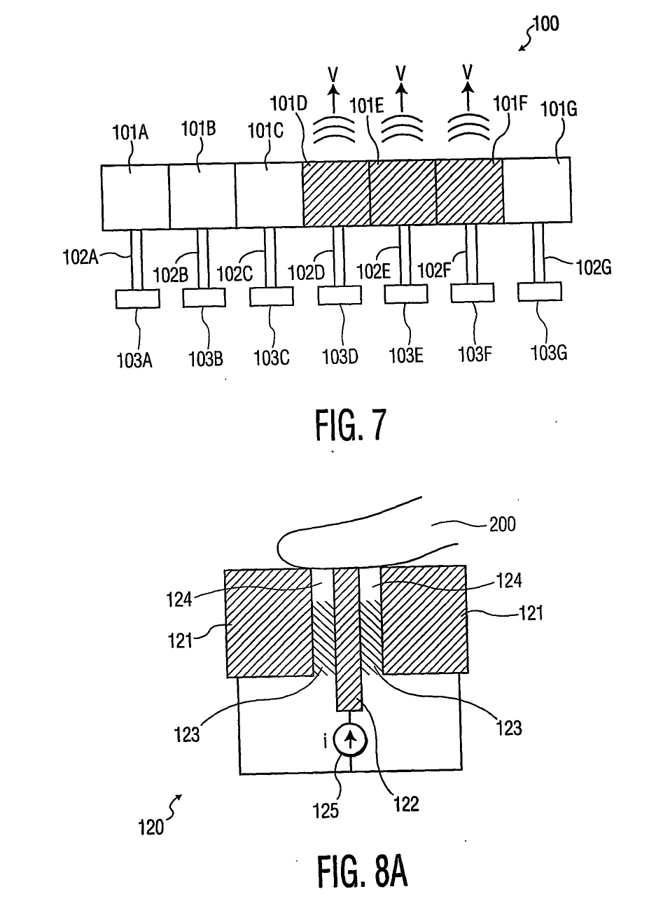

FIG. 7 shows a side sectional view of a control panel with a vibrotactile display, in accordance with the present invention;

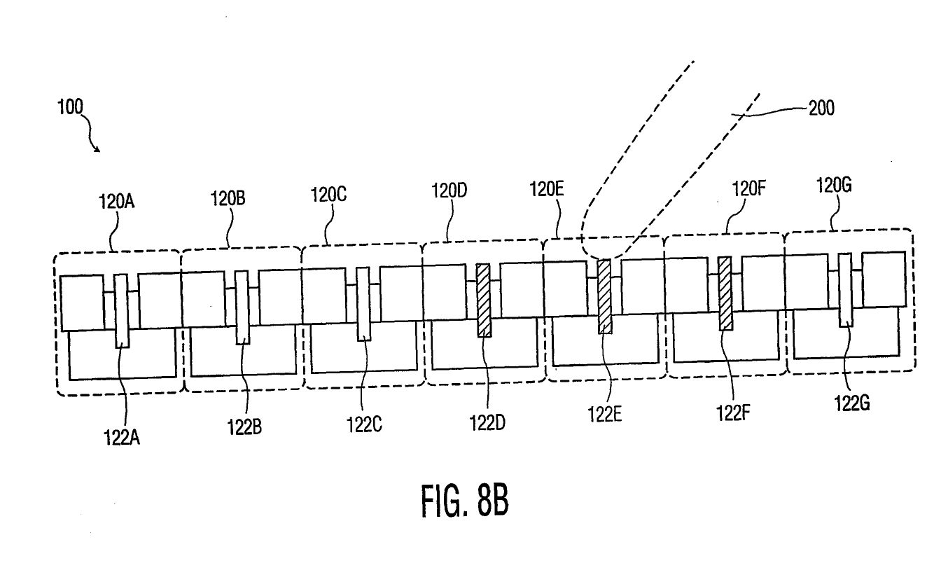

FIG. 8A shows a side sectional view of a portion of a control panel with an electrotactile display, in accordance with the present invention;

FIG. 8B shows a side sectional view of a control panel with an electrotactile display, in accordance with the present invention;

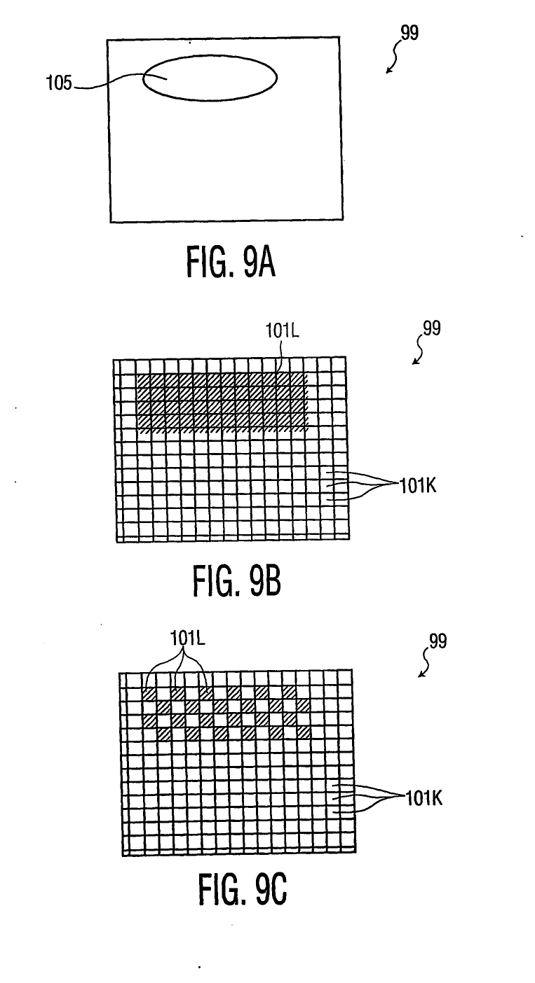

FIG. 9A shows a plan view of a portion of a centralized-type vibrotactile display, in accordance with the present invention;

FIG. 9B shows a plan view of a portion of a distributed-type vibrotactile display, in accordance with the present invention;

FIG. 9C shows a plan view of another embodiment of a portion of a distributed-type vibrotactile display, in accordance with the present invention;

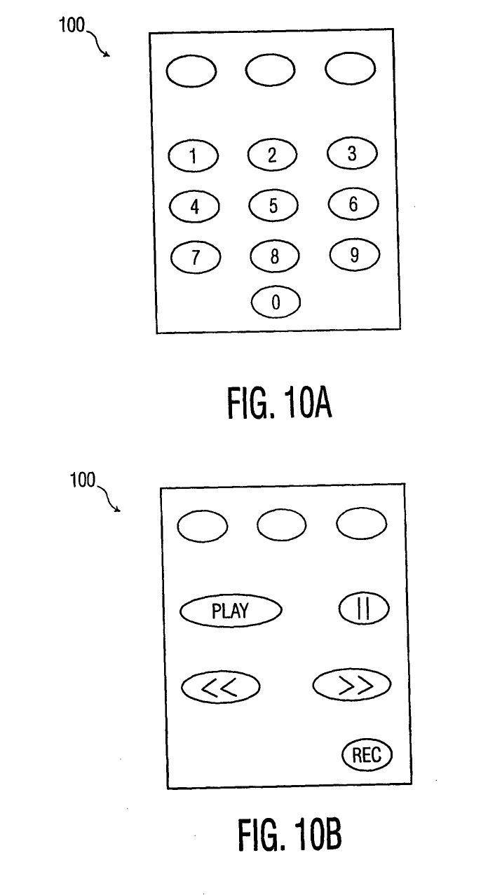

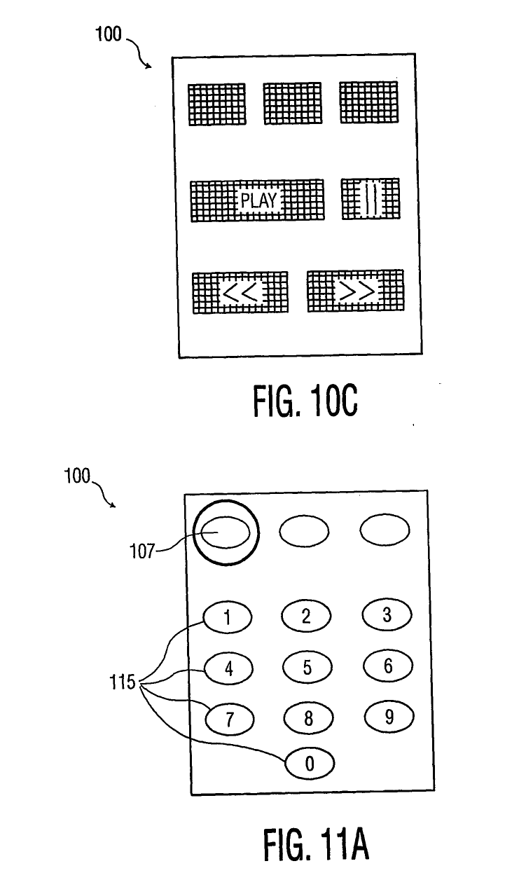

FIG. 10A shows a plan view of a centralized-type vibrotactile display depicted a TV display interface, in accordance with the present invention;

FIG. 10B shows a plan view of a centralized-type vibrotactile display depicted a VCR display interface, in accordance with the present invention;

FIG. 10C shows a plan view of a distributed-type vibrotactile display depicted a VCR display interface, in accordance with the present invention;

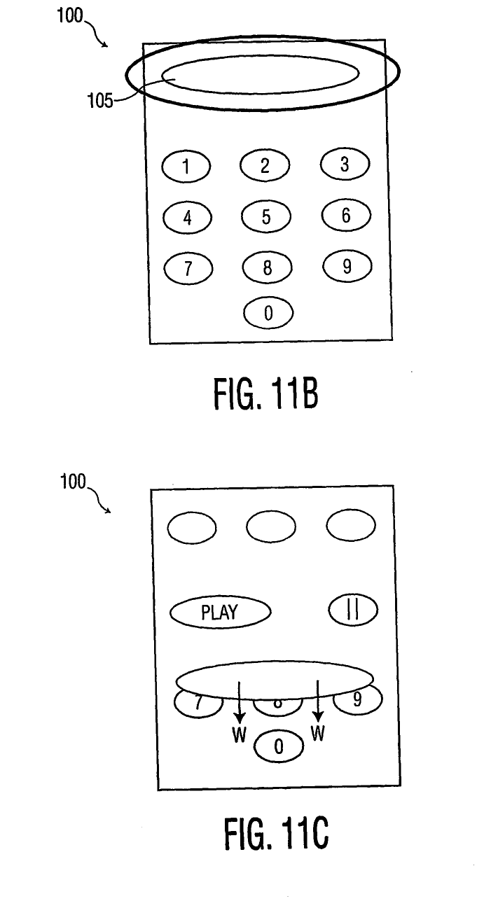

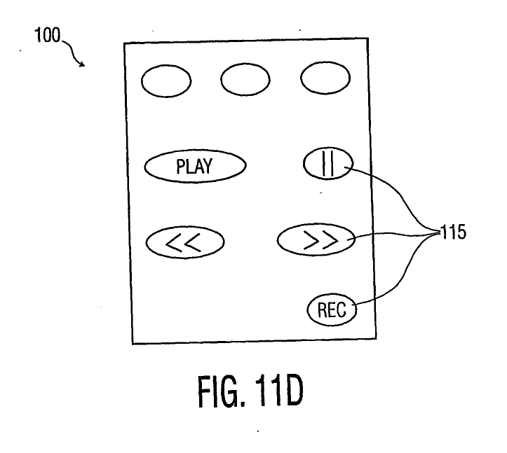

FIG. 11A shows a plan view of an embodiment of a control panel depicting a TV display interface, in accordance with the present invention;

FIG. 11B shows a plan view of an embodiment of a control panel depicting a TV display interface starting a transition to a VCR display interface, in accordance with the present invention;

FIG. 11C shows a plan view of an embodiment of a control panel depicting a TV display interface further transitioning to a VCR display interface, in accordance with the present invention; and

FIG. 11D shows a plan view of an embodiment of a control panel depicting a VCR display interface, in accordance with the present invention.

FIG. 3 shows the GUI 50 of a remote control unit incorporating the subject invention. The GUI includes three regions, an information section 52 which includes information for the selected device, a device selection section 54 for displaying control icons for selecting the desired device, e.g., TV 58 and LD (laser disc) 60, and a control function section 56 for displaying control icons for controlling the desired device, in this case, numbers 1-0 icons 61-70.

FIG. 4 shows an edge view of the GUI 50 where it will be apparent that surface of the GUI in the vicinity of the icons 62, 64, 66, 68 and 70 is raised. It should be understood that while FIG. 4 only shows some of the icons being raised, the surface of the GUI in the vicinity of other icons, including 58, 60, 61, 63, 65, 67 and 69, may also be raised.

Once a user of the remote control unit 50 is familiar with the layout of the control icons, the user is then able to select the appropriate icon by merely sliding his/her finger across the surface of the GUI thereby detecting the raised areas and then selecting the desired control icon represented by the appropriate raised area.

While this embodiment of the invention allows for a user to discern the various control function by touch, when the raised areas are formed in the surface of the GUI, the layout of the control icons on the display may not be changed.

FIG. 5 shows a second embodiment of the invention in which the touch sensitive display is a flexible display. U.S. Pat. No. 6,368,730 discloses an electroluminescent device which is flexible and may be used for the display in the GUI 50′. The raised portions 62′, 64′, 66′, 68′ and 70 are formed by actuators 72.0-72.9 arranged beneath the flexible display 50′.

Each of the actuators 72.0-72.9 includes a pusher rod 74.1-74.9 which, upon activation of the respective actuator, presses on the under-surface of the flexible display 50′. Hence, in order to accommodate the icons forming the numbers “2”, “4”, “6”, “8” and “0”, as shown in the GUI 50 of FIG. 3, the actuators 72.1, 72.3, 72.5, 72.7 and 72.9 are activated, while the actuators 72.2, 72.4, 72.6 and 72.8 are deactivated.

In order to accommodate various layouts of control icons on the flexible display 50′, as shown in FIG. 6, the actuators may be arranged in an actuator array 80 forming a matrix having a plurality of rows of actuators and columns of actuators. The rows of actuators in the actuator array 80 are addressed by a row interface 82, while the columns of actuators in the actuator array 80 are addressed by a column interface 84. An actuator controller 86 is then connected to the interfaces 82 and 84 for activating selected ones of the actuators corresponding to the location of the control icons as controlled by a display controller 88.

With such an arrangement, small control icons may be raised using a single actuator, while larger control icons may be raised using multiple adjacent actuators. In fact, if the actuators are sufficiently small, a plural number of actuators may be used to form a raised distinguishable shape for the icon (e.g., an arrow), or may be used to form a type of rocker switch.

While the invention so far has been described in the sense of forming raised areas on the surface of the display, it should be understood that, instead, depressions in the surface of the display by alternatively be formed. To this end, the pusher rods 74.1-74.9 of the actuators 72.1-72.9 are attached to the under-surface of the display 50′. Depending on the control signal applied to each actuator 72.1-72.9, the respective pusher rod 74.1-74.9 may press upwardly on the display (e.g., 74.1), remain in a neutral position (e.g., 74.2), or may pull down on the display.

While the invention contemplates touch sensitivity on the part of the display, it should be noted that this feature has not been disclosed for the electroluminescent device of U.S. Pat. No. 6,368,730. Hence, in order to provide for such, the actuator controller 86 may also detect pressure on, for example, the activated actuators, this pressure resulting from a user pressing the desired icon (note the two-way arrows connecting the interfaces 82 and 84 to the actuator array 80, and the two-way arrows connecting the interfaces 82 and 84 to the actuator controller 86).

It should be noted that while the above description relates to the GUI layout as shown in FIG. 3, and in particular, to the bottom row of the GUI therein, the subject invention is applicable to other layouts. For example, the subject invention may be used to impart touch detectability to the display of the remote control unit shown in FIGS. 1 and 2. In particular, the small icons, e.g., 32, 34 and 36, may be accommodated by activating single actuators in the actuator array, while larger icons, e.g., 38, may be accommodated by activating two or more actuators.

Disclosed next are two additional embodiments for providing tactile, or touch, detectability to the GUI in the present invention. First, there is a vibrotactile display (i.e., at least one surface vibration) on the GUI; and, second, there is a electrotactile stimulation (i.e., electrocutaneous) on the GUI.

FIG. 7 shows a side sectional view of a control panel 100 depicting the vibrotactile display embodiment (i.e., first type of tactile display). A plurality, or array, of cells 101 (i.e., 101A-101G), which are connected via a plurality of pusher rods 102 (i.e., 102A-102G) to a plurality of actuators 103 (i.e., 103A-103G). The actuators 103 provide the means of vibration to the various cells 101. In FIG. 7 three of the actuators 103D, 103E, 103F are activated and, thus, providing vibrations to cells 101D, 101E, 101F, respectively. The vibration of the cells 101D, 101E, 101F are depicted by directional arrows “V”. Actuators 101 can be driven by various means that can ultimately create at least one vibration in a respective cell such as piezoelectric crystals, small motors, etc. (not shown).

Conversely, FIGS. 8A and 8B show side elevation sectional views depicting a portion of a control panel 100, and a control panel 100, respectively, with the second embodiment of providing tactile detectability (i.e., electrotactile stimulation). A plurality of cells 101 make up a control panel 100 in the vibrotactile embodiment (See FIG. 7), while a plurality of electrode-skin interface cells 120 (i.e., 120A-120G) make up a control panel 100 in the electrotactile embodiment (See FIG. 8B). A single electrode-skin interface cell 120 (i.e., 120A-120G) depicted in FIG. 8A typically includes an active electrode 122 (i.e., 122A-122G) situated between two return electrodes 121. The active electrode 122 is separated from the return electrodes by insulators 123 and air gaps 124 located above the insulators 123. An electrical current 125 is provided to the active electrode 122. When a user's finger(s) 200 (shown in phantom in FIG. 8B) touches the active electrode 122 and concurrently touches one, or both, of the return electrodes 121 (i.e., closes the electrical circuit), the electrical current flows from the center active electrode 125 through the skin and subcutaneous tissue of the user back through to one or both of the return electrodes 121. As a result, the user feels an electrotactile stimulation (i.e., mild electrical shock). In FIG. 8B three of the active electrodes 122D, 122E, 122F all are being provided with electrical current thereby activating electrotactilely three electrode-skin interface cells 120D, 120E, 120F, respectively from the control panel 100.

FIGS. 9A and 9B both show plan views of a portion of a control panel 99. In what is termed as a centralized-type (FIG. 9A) of vibrotactile display a portion of the control display (i.e., screen) 99 is made of a flexible material (e.g., plastic, etc.). In this manner, when an actuator 103 is activated to vibrate a portion of the control display 99, not only will the portion of the control display 99 immediately above the actuator vibrate, but the vibration effect will be transmitted in a whole adjacent area around an initial vibration point, as connoted by the vibration “node” 105. Alternatively, FIG. 9B depicts what is termed as a distributed-type of vibrotactile display. In the distributed-type of vibrotactile display, there is an array, or matrix, of cells 101. In FIG. 9B, the shaded cells 101L are each vibrating while the unshaded cells 101K are each not vibrating. An alternative embodiment of a distributed-type vibrotactile display is shown in FIG. 9C. Similarly, the shaded cells 101K are each vibrating, while the non-shaded cells 101L are each not vibrating. By varying the layout, pattern, or density, of which cells are each vibrating, or not, a different vibrotactile sensation, or feel, can be created. For example, although the perimeter of the vibrating area of both FIG. 9B and FIG. 9C is similar, the texture, or feel, of the vibrating areas in FIG. 9B and FIG. 89 will differ.

Now with any of the preceding vibrotactile systems of FIGS. 9A-9C the vibrations can be pre-set or be programmable by an end-user. The vibrations can be set in an infinite combination of settings. By varying the characteristics of a vibration, the user can identify the function, control icon, or status of the control panel 100. Various characteristics that can be changed include the texture, the frequency, the granularity, the duration, the amplitude, and the location of the vibration.

The frequency of the vibration is the rate at which an actuator 103 activates to vibrate a particular cell 101, as in the distributed-type of vibrotactile system, or vibrate the control panel 100 as a whole, as in the centralized-type of vibrotactile system. Frequencies may run from about 30 Hz to as high as about 1 kHz.

The texture of the vibration includes the feel to the hand of the user of the vibration. For example, in the distributed-type, the texture may be adjusted by varying how many of the cells 101 are vibrating and in what pattern the cells 101 are vibrating. This difference in texture of vibration is shown, and discussed above, in FIGS. 9B and 9C.

The granularity of the vibration can be altered. The granularity of the vibration refers to the smallest unit of vibration. Thus, each cell 101 may be the smallest unit of vibration.

For example, the granularity can be between about 1 mm and about 5 mm. The granularity can be configurable on the device.

The amplitude of the vibration would be the strength at which the various vibration means actuate (i.e., vibrate) a given cell 101 or area of the control panel 100. The amplitude can be programmable.

The duration and location of the vibration can likewise be programmable. The duration is the length of time a particular vibration is maintained. The location of vibration is the exact location of cell 101, or cells 101, on the control panel 100 that is/are vibrating.

Thus, by programming the various aforementioned vibrotactile characteristics to the control panel 100, a nearly infinite amount of patterns can be created. Similarly, various characteristics for the electrotactile display can be programmed to create different sensations.

For example, similar control icons on different display interfaces can have similar tactile characteristics. Also, the various control icons can have tactile characteristics, while the surrounding display area (i.e., background) has no tactile characteristics. Conversely, the display interface can be programmed with an opposite arrangement. That is, the control icons could have no tactile characteristics, while the surrounding areas of display exhibit the tactile characteristics. Additional features can be provided such as a screen saver whereby the tactile effect, be it electroctactile or vibrotactile, is off or at a lower energy while the control device is not being used. When the user picks up the control device, or touches a control icon or the control panel, the system is activated and the full tactile effects are maximized. This feature saves energy.

FIGS. 10A, 10B, and 10C all show various embodiments of display interfaces (i.e., screens) of a control display 100. FIG. 10A, for example, shows a display interface of a control panel 100 utilizing the centralized-type of electrotactile display, in this case, depicting the various buttons for a TV display interface. FIG. 10B shows a display interface of a control panel 100 utilizing the centralized-type of electrotactile display, in this case, depicting the various buttons for a VCR display interface. FIG. 10C shows a display interface of a control panel 100 conversely utilizing the distributed-type of electrotactile display, again, depicting the various buttons for a VCR display interface.

Thus, by pressing a specific button on the display interface, the user can have the control panel 100 switch, or transition, between display interfaces (i.e., screen displays).

FIGS. 11A through 11D show a plan view of a control panel 100 with the progression of transitioning from the display interface for a TV (FIG. 11A) to the display interface for a VCR (FIG. 11D). Various control icons 115 are depicted in the figures which serve to provide control functions to at least one device. When the user wishes to transition the control panel 100 from one display interface for a particular device (e.g., TV) to a second display interface for a second device (e.g., VCR), he/she presses a specific control icon 107 which changes the display. The invention provides a particular tactile display, or effect, to the control panel 100 so that the user knows, via feel, that the control panel 100 is transitioning from a first display interface to a second display interface. This transitioning effect can be accomplished via either the vibrotactile display or the electractile display.

For example, this particular tactile display denoting the transitioning of the display interfaces could be a “wave effect”. That is, as depicted in FIGS. 11B and 11C, like a wave, at least one vibration area 105 could spread across the control panel 100; hence, the term “wave effect”. This “wave effect” could be a unique vibration moving across the control panel 100, from side to side; or, from top to bottom; or, some similar effect. The “wave effect” vibration area 105 could have different vibration characteristics than other vibrations on the control panel 100, thereby allowing the user to sense and know that the transitioning is taking place between display interfaces. A leading edge of the “wave effect” is denoted by directional arrows “W”.

Numerous alterations and modifications of the structure herein disclosed will present themselves to those skilled in the art. However, it is to be understood that the above described embodiment is for purposes of illustration only and not to be construed as a limitation of the invention. All such modifications which do not depart from the spirit of the invention are intended to be included within the scope of the appended claims.

1. A control panel for a device, comprising:
a graphical user interface (GUI) displaying a plurality of control icons, wherein the plurality of control icons represent a plurality of corresponding control functions for controlling the device; and
means for providing tactile detectability to said GUI to allow a user to detect at least one of the plurality of control icons by touch.

2. The control panel as in claim 1, wherein said means for providing tactile detectability provides at least one surface vibration to said GUI.

3. The control panel as in claim 2, wherein said at least one surface vibration is in a range of about 10 Hz to about 1 kHz.

4. The control panel as in claim 2, wherein at least two of the plurality of control icons have different surface vibrations.

5. The control panel as in claim 2, wherein said at least one surface vibration is present on at least one control icon of said plurality of control icons and not present on a surrounding area of display.

6. The control panel as in claim 2, wherein said at least one surface vibration is present on an area of display surrounding said plurality of control icons and not present on said plurality of control icons.

7. The control panel as in claim 5, wherein said at least one surface vibration is present on all of said control icons of the plurality of control icons and not present on a surrounding area of display.

8. The control panel as in claim 1, wherein said means for providing tactile detectability provides electrotactile stimulation to said GUI.

9. The control panel as in claim 1, further wherein said GUI displays a plurality of user-selectable and user controllable functionalities distributed over multiple display interfaces in a control hierarchy of a system.

10. The control panel as in claim 9, wherein said system is a consumer electronics system.

11. The control panel as in claim 9, wherein a surface vibration of the at least one surface vibration is provided to said GUI when the user is transitioning between the multiple display interfaces of the control hierarchy.

12. A method, comprising:
providing a control device including a display for displaying a graphical user interface (GUI);
displaying on the GUI a plurality of control icons representing various control functions wherein the control functions enable a user to control a system through the GUI; and
adapting at least one of the plurality of control icons so as to be detectable by a user via means selected from the group of vibrotactile means, electrotactile means, and combinations thereof.

13. The method as in claim 12, wherein said vibrotactile means include at least one vibration in a range of about 10 Hz to about 1 kHz.

14. The method as in claim 12, wherein at least two of the plurality of control icons have a different vibrotactile characteristic.

15. The method as in claim 12, wherein at least one vibrotactile characteristic is present on at least one control icon of said plurality of control icons and not present on a surrounding area of display.

16. The method as in claim 12, wherein at least one vibrotactile characteristic is present on an area of display surrounding said plurality of control icons and not present on said plurality of control icons.

17. The method as in claim 15, wherein at least one vibrotactile characteristic is present on all of said control icons of said plurality of control icons and not present on a surrounding area of display.

18. The method as in claim 12, further wherein said GUI display a plurality of user-selectable and user controllable functionalities distributed over multiple display interfaces in a control hierarchy of a system.

19. The method as in claim 18, wherein said system is a consumer electronics system.

20. The method as in claim 18, wherein at least one surface vibration is provided to said GUI when the user is transitioning between the multiple display interfaces of the control hierarchy.
